(19) United States
(12) Patent Application Publication
(10) Pub. No.: US 2021/0327292 A1
(43) Pub. Date: Oct. 21, 2021

(54) Method For Multiple-Choice Quiz Generation

(71) Applicant: Don Johnston Incorporated, Volo, IL (US)

(72) Inventors: Neil M. Goldman, Lockport, IL (US); Kevin Johnston, Libertyville, IL (US)

(21) Appl. No.: 17/271,044

(22) PCT Filed: Sep. 17, 2019
(86) PCT No.: PCT/US19/51402

§ 371 Date: Feb. 24, 2021

Related U.S. Application Data
(60) Provisional application No. 62/740,078, filed on Oct. 2, 2018.

(51) Int. Cl. G09B 7/06; G09B 19/00

(52) U.S. Cl. CPC G09B 7/06; G09B 19/00

(57) ABSTRACT

A system and method for automatically generating a multiple-choice quiz which consists of computer-generated vocabulary and comprehension questions, maze, and doze along with the answer key derived from an English text passage of arbitrary length and arbitrary content provided by a user. The system contains a plurality of client computers and a plurality of quiz generation servers and can send automatically generated quizzes to 3rd party quiz taking tools (e.g., Google Forms, Quizlet). The system permits one or more users to use client computers to submit a text passage and to select configuration options for configuring the content of the completed quiz, transmitting the passage and configuration options to one or more quiz generation servers which generate a quiz and answer key while obeying the user-transmitted configuration options, transmitting the completed quiz along with embedded answer key to 3rd party quiz taking tools so that it may be subsequently retrieved, presented to, and answered by a plurality of quiz-answering users using the client computers, and scored according to the embedded answer key.

### I. CROSS-REFERENCE TO RELATED APPLICATION

This patent application is a non-provisional application claiming priority from U.S. Provisional Patent Application Ser. No. 62/740,078, entitled Method For Multiple-Choice Quiz Generation, filed on Oct. 2, 2018, and is fully incorporated herein by reference.

### II. FIELD OF THE INVENTION

The present invention relates to automatic multiple-choice quiz generation, and, more particularly, to a unique method for generating a multiple-choice vocabulary quiz, reading comprehension quiz, or combined vocabulary and reading comprehension quiz to a plurality of students which requires only that a user submit an arbitrarily-chosen passage of English text.

### III. SUMMARY OF THE INVENTION

The present invention is an automated system and method for generating a quiz from an arbitrary passage of text. The hardware and software of the system and method permit multiple unique quizzes to be generated by multiple simultaneous users each of which are generating quizzes based on possibly different text passages. Each quiz is generated by a user by selecting an arbitrary passage of text, optionally selecting quiz options, and then performing one click or finger-tap which selects a function which generates the quiz. This quiz-generation function results in the user-selected text passage and user-selected options being transmitted to a quiz-generation server which generates a quiz and answer key from the transmitted text passage and options, and which then transmits the resulting quiz to the desired 3rd party quiz tool. Upon the quiz being thus generated and created within the 3rd party quiz tool, the user is notified of the completion of the quiz generation process and is provided with a unique quiz link that opens the created quiz within the 3rd party quiz tool where the quiz can then be administered and scored.

### IV. BRIEF DESCRIPTION OF THE DRAWINGS

The Description of the Preferred Embodiment will be better understood with reference to the following figures:

FIG. 1 is a diagram illustrating the arrangement of the network and hardware of the components of the invention.

FIG. 2 is a flowchart illustrating an overview of steps users take when using the invention.

FIG. 3 is a diagram of key files accessed by a quiz generation server, a component of the invention.

FIG. 4 is a flowchart illustrating the steps the software system takes to generate a quiz.

FIG. 5 is a diagram of a web browser screen that contains a browser extension icon which permits a user to use the system to generate a quiz.

FIG. 6 is a diagram of the user menu through the browser extension available when the user begins using the system to generate a quiz.

FIG. 7 is a diagram of the browser extension options menu available for a user while using the system to generate a quiz.

FIG. 8 is a diagram of an information box which appears while using the system to generate a quiz.

FIG. 9 is a diagram of the first visible screen of the created quiz within the 3rd party quiz tool (in this case, Google Forms) which appears once the quiz has been created and sent to the 3rd party quiz tool's API to create the quiz.

FIG. 10 is a diagram of a multiple-choice question within the 3rd party quiz tool (in this case, Google Forms).

FIG. 11 is a diagram of a screen which permits a user to view existing quizzes or generate a new quiz from text copied from on-screen sources within or outside of a browser window.

FIG. 12 is a diagram of a screen which permits a user to name a quiz and submit an arbitrary text passage which is the basis for generating a quiz.

FIG. 13 is a diagram of quiz generation options presented to a user prior to generating a quiz when using the screen pictured in FIG. 12.

FIG. 14 is a visual representation of the contents of the word/letter pattern file, and how the system matches patterns to create comprehension questions.

FIG. 15 is a visual representation of the contents of the comprehension question distractor file, which permits the user to create distractor choices (incorrect choices) for the multiple-choice comprehension quiz.

### V. DETAILED DESCRIPTION OF THE PREFERRED EMBODIMENT

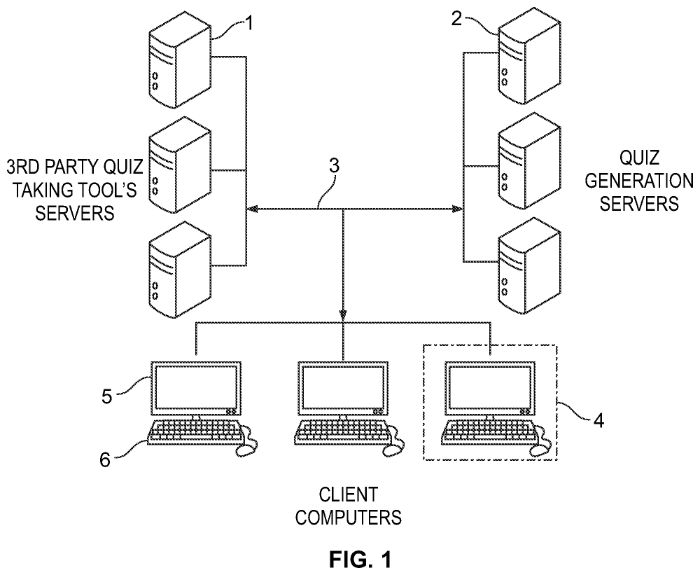

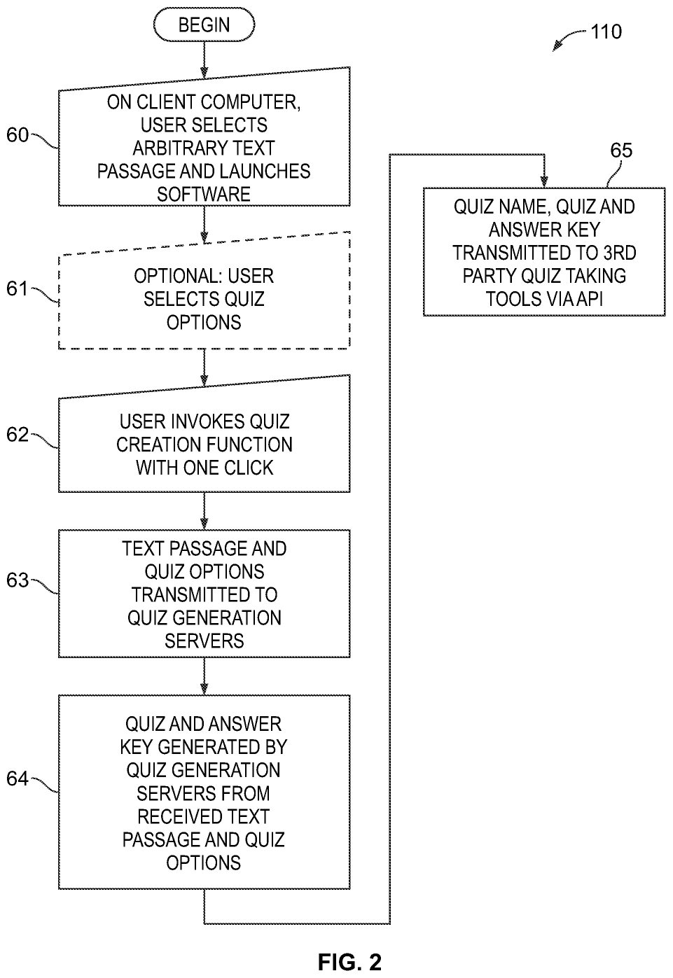

The invention consists of the interaction between computer hardware, as illustrated in FIG. 1, and computer software (“system”), as illustrated in FIGS. 2 through 15.

Turning to FIG. 1, the computer hardware consists of a plurality of client computers 4 each consisting of a screen 5 and an input device 6, a plurality of 3rd party quiz tool servers (e.g., Google Forms, Quizlet) 1 and a plurality of quiz generation servers 2 communicating with each other over a computer network via an API 3.

The computer hardware and system are used by “quiz-creation users,” who use the hardware and system to generate quizzes and send those quizzes to the desired 3rd party quiz tool. “Quiz-taking users,” will not interact with the invention, but will “take” the quiz on the desired 3rd party quiz tool, meaning, answer the quiz questions presented by selecting one or more correct choices from a plurality of choices presented for each of a plurality of quiz questions presented.

In the preferred embodiment, there may be only one correct answer choice within a plurality of possible answer choices for each question, or there may be a plurality of correct answer choices within a plurality of possible answer choices for each question.

Turning to FIG. 2, an overview of the operation of the invention is shown as a series of steps of the “quiz-creation” phase 110, most likely performed by a teacher, where a quiz is created from an arbitrarily selected passage of text.

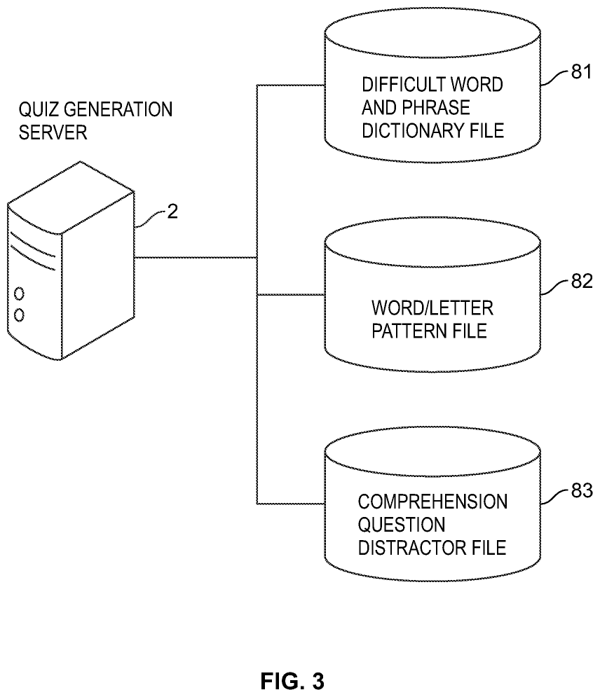

The steps depicted in FIG. 2, which describe the overall operation of the invention from beginning to end, are illustrated in more detail in FIGS. 3-15. The steps depicted in FIG. 2 will be described in sequence, with references being made to FIGS. 3-15 to provide detail of each step as needed.

The sequence of steps of the invention begins with a quiz-creating user, while using a client computer, selecting an arbitrary text passage (shown as step 60) by selecting text on the screen using commonly known highlight-and-copy procedures available on every computer, tablet, and cell phone.

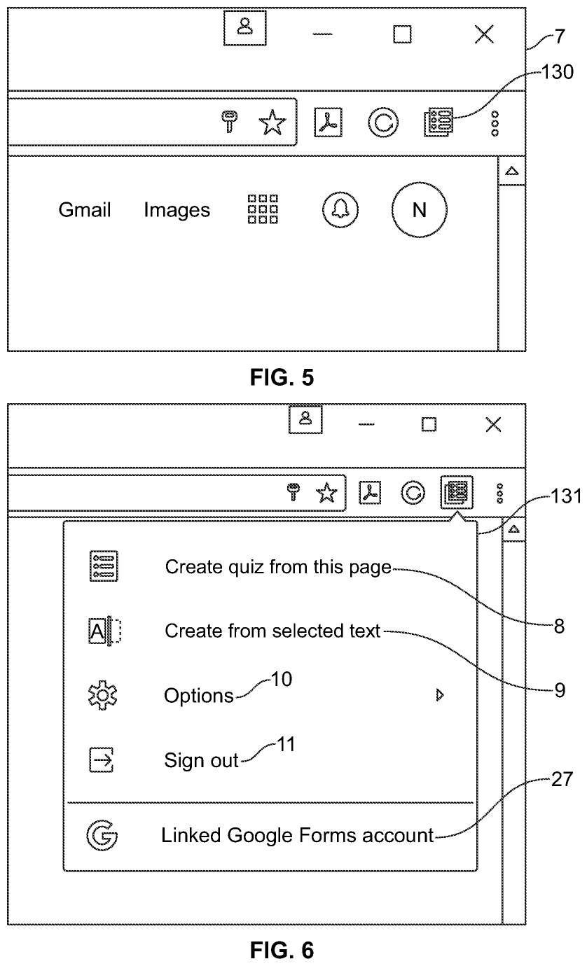

Upon selecting said text in browser window (FIG. 5) 7, user clicks software launch button 130 to launch the software.

Upon launching the software, the user is presented with a menu (FIG. 6) 131 which contains four choices.

Menu choice 8 allows the user to create a quiz from all the text on the current web browser screen 7, or, if there is an <article> tag present (a tag that specifies independent, self-contained content), just the text of the article.

Menu choice 9 allows the user to create a quiz from the currently selected/highlighted text.

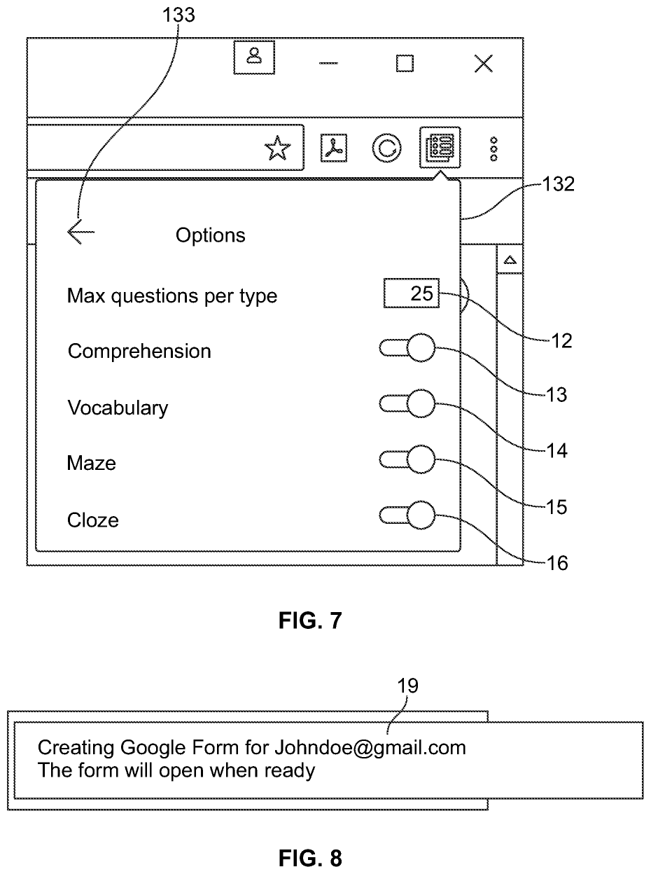

Menu choice 10 describes optional step 61 in FIG. 2. Clicking this menu choice results in an option menu (FIG. 7) 132 being displayed. Option menu 132 has an option 12 which permits the user to select the maximum questions per question type, an option 13 which permits the user to include or exclude comprehension questions, an option 14 which permits the user to include or exclude vocabulary questions, an option 15 which permits the user to include or exclude maze questions, and an option 16 which permits the user to include or exclude cloze questions. Upon the user being satisfied with the selected options, the user clicks arrow 133 which saves the options and returns the user to the previous menu 131.

Returning to FIG. 6, menu choice 11 permits the user to sign out of the software if desired. Menu choice 27 shows the account of the 3rd party quiz tool where the quiz will be sent after creation (in this case, the Google Forms account).

To create a quiz, the user then selects either menu option (FIG. 6) 8 or menu option 9, as desired. This is illustrated as step 62 in FIG. 2.

FIG. 8 shows an alert message 19 which notifies the user that the quiz is being generated. Returning to FIG. 2, the system performs step 63 by transmitting the user-selected text passage and encoded option choices to a quiz-generation server 2. Upon a quiz-generation server 2 receiving the text passage and options, it automatically generates a quiz as shown in step 64.

The process of generating a quiz will now be explained. FIG. 3 shows that a quiz generation server 2 contains three files: a difficult word and phrase dictionary file 81 which contains a list of difficult words and phrases along with brief definitions of each word or phrase, a word/letter pattern file 82 which contains a list of patterns to match within the text in an attempt to generate comprehension questions, each pattern consisting of combinations of words, numbers, spaces, punctuation, and upper and lower-case letters, and a comprehension question distractor file 83 which contains a list of entries that can be used as distractors (incorrect answer choices) within the multiple-choice questions generated by the quiz.

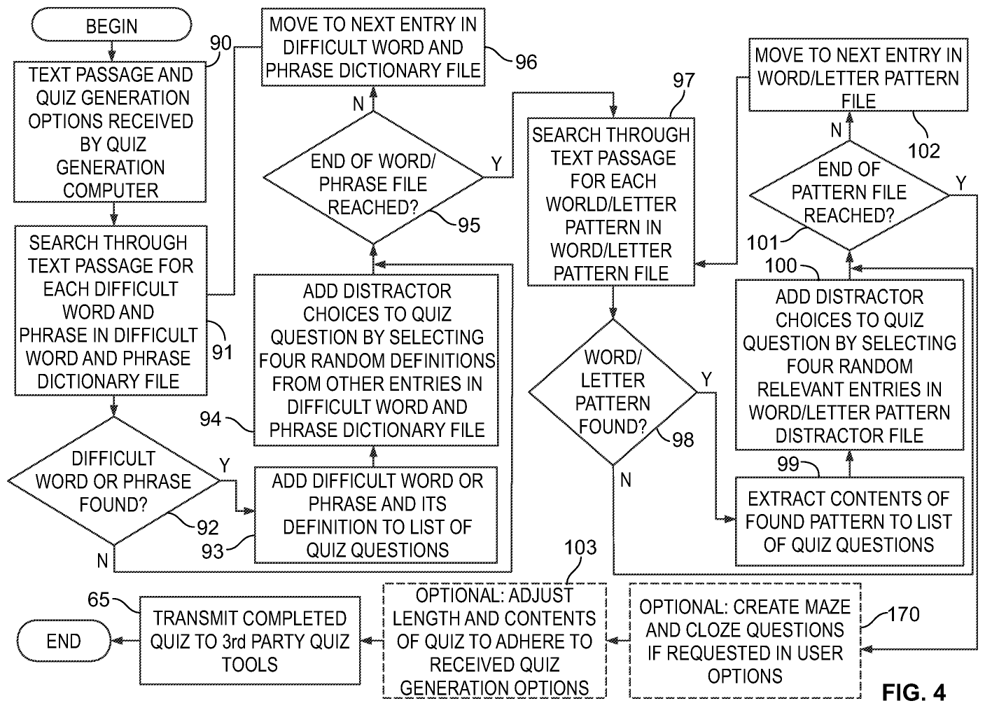

Turning to FIG. 4, which represents step 64 in FIG. 2, step 90 shows a quiz generation server 2 receiving an arbitrary text passage and quiz generation options from a user. The quiz generation server 2 reads difficult word and phrase dictionary file 81 and, in step 91, searches through the text passage for each difficult word and phrase within the difficult word and phrase dictionary file 81. If a difficult word or phrase is found, shown as step 92, the quiz generation server 2 adds the difficult word or phrase and its definition to the list of quiz questions, shown as step 93. This results in an incomplete quiz question with only one answer choice: the correct one. To add necessary distractors, or incorrect answer choices, to the quiz question, the quiz generation server 2 then randomly selects from the difficult word and phrase file 81 a plurality of definitions none of which match the currently-selected difficult word or phrase which is the subject of the question, and adds these distractors (shown as step 94) to the quiz question, resulting in a complete quiz question comprising a question, a correct answer, and a plurality of distractors, or incorrect answer choices. The preferred embodiment results in four or five total answer choices, one of which is the correct answer and four of which are incorrect distractors, but the invention could produce any number of total answer choices.

The system then tests if the end of the difficult word and phrase file 81 has been reached, shown as step 95. If it has not been reached, the system then searches through the text for the next difficult word or phrase within the difficult word and phrase dictionary file 81, again shown as step 91. If the end of difficult word and phrase dictionary file 81 has been reached, the system then reads the word/letter pattern file 82 and searches the text for each word/letter pattern in the word/letter pattern file 82, shown as step 97. This process will now be described.

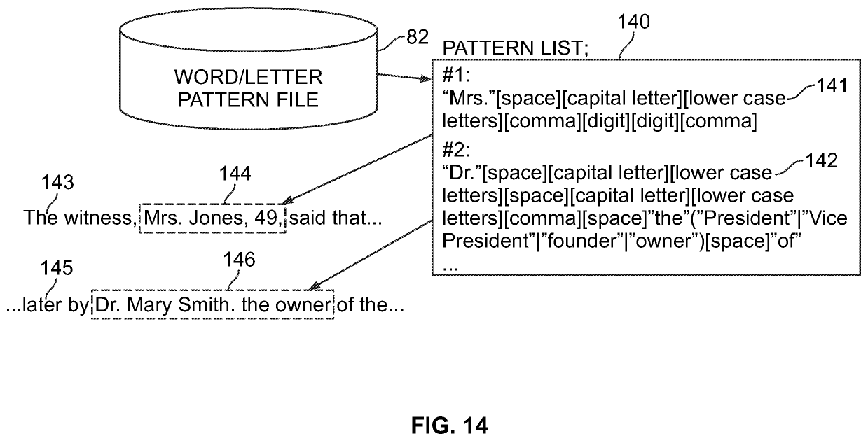

Turning to FIG. 14, the word/letter pattern file 82 consists of a pattern list 140. The pattern list contains a plurality of entries, two examples of which are shown here as 141 and 142.

For purposes of example and illustration, the following sequences are detailed. Looking at pattern 141, the pattern instructs the software to search the text passage for the letters “Mrs.”, then a space, then a capital letter, then one or more lowercase letters, then a comma, then a digit, then a digit, and then a comma. Upon the software examining text fragment 143, a positive match 144 is found depicted by a dashed box which contains the text “Mrs. Jones, 49,”. The software then further examines and parses that positive match to separate the human name (Mrs. Jones) and her age (49), and this information is used in the generation of a comprehension question, such as, “How old is Mrs. Jones?”

Looking at pattern 142, the pattern instructs the software to search the text passage for the letters “Dr.”, then a space, then a capital letter, then one or more lowercase letters, then a space, then a capital letter, then one or more lowercase letters, then a comma, then a space, then the letters “the”, then either the letters “President” or “Vice President” or “founder” or “owner”, then a space, then the letters “of”. Upon the software examining text fragment 145, a positive match 146 is found depicted by a dashed box which contains the text “Dr. Mary Smith, the owner”. The software can then further examine and parse that positive match to separate the human name (Dr. Mary Smith) and her occupation (owner), and this information can be the basis of a comprehension question, such as “What is the job title of Dr. Mary Smith?”

This permits the system to extract the contents of a plurality of found patterns to add them to the list of quiz questions, shown as step 99 in FIG. 4.

Upon the system creating comprehension questions using the method shown in FIG. 14, the system must then create distractors (incorrect answer choices) for those multiple-choice comprehension questions.

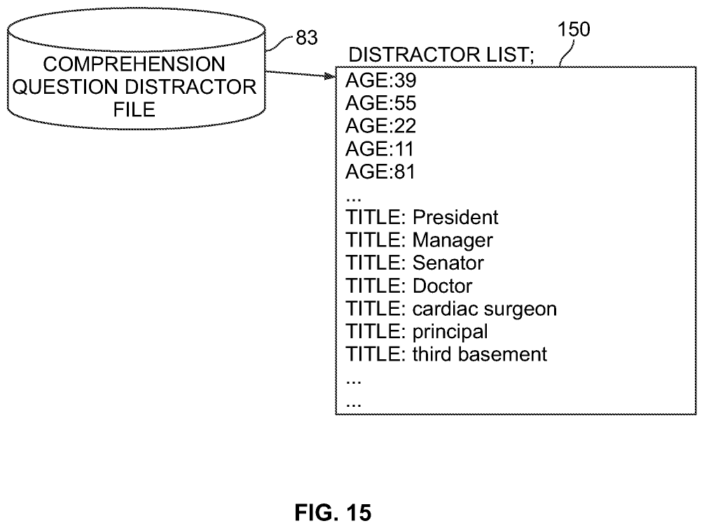

Turning to FIG. 15, we see the comprehension question distractor file 83 which contains a distractor entry list 150 which contains a plurality of distractor entries. Each entry is coded as to the type of distractor entry: age, title, and so on. To create distractors, the software randomly selects, from each correctly-coded entry, enough distractors of the correct distractor type which do not match the found pattern so that a multiple-choice question is created with the desired quantity of question choices, usually 4 or 5, shown as step 100 in FIG. 4.

Returning to FIG. 4, the system then tests if the end of the word/letter pattern file 82 has been reached, shown as step 101. If it has not been reached, the system then moves to the next entry in the word/letter pattern file 82, shown as step 102. If it has been reached, the system then optionally creates maze and doze questions, shown as step 170.

Maze questions are well-known in reading comprehension instruction, and can be created from a text passage by one skilled in the art. A text passage is examined, and, beginning with the second sentence and continuing to the end of the passage, every, for example, seventh word (or, alternatively, any other desired number) could be replaced with three randomly-appearing choices: the original word and two distractors. The maze test-taker then selects the correct word from the three choices. Selecting the correct word indicates comprehension of the passage.

Example Maze:
“The dog walked down the street (leaf, bird, wagging) its tail. Many children tried to (that, during, pet) the dog, but . . . ”

Cloze questions are also well-known in reading comprehension instruction. In a doze passage, all difficult words in a passage are replaced by an underline or blank. The list of all replaced difficult words are displayed in a word bank. The user must select words from the word bank and insert them into the correct blank or space in the text. Correctly selecting words and inserting them into the correct blanks demonstrates the user's understanding of the words and his or her comprehension of the passage.

Example Doze:
Word bank: assuage, vista.
   Passage:
      The caring father tried to ______ the child's anxiety by showing her a beautiful ______ of a sunset.

Upon creation of the maze and doze questions, the system adjusts the length and contents of the quiz as shown as step 103 in FIG. 4 so that the quiz adheres to the received quiz generation options selected by the quiz-generation user on screen 132 in FIG. 7, and then the system transmits the completed quiz to the 3rd party quiz tool's servers 1, shown as step 65 in FIG. 2.

In the preferred embodiment, the difficult word or phrase, as described in FIG. 4, steps 90 through 95, creates vocabulary questions; and the word/letter pattern, as described in FIG. 4, steps 97 through 101, creates comprehension questions, which collectively result in one completed quiz providing multiple-choice questions of both vocabulary and comprehension.

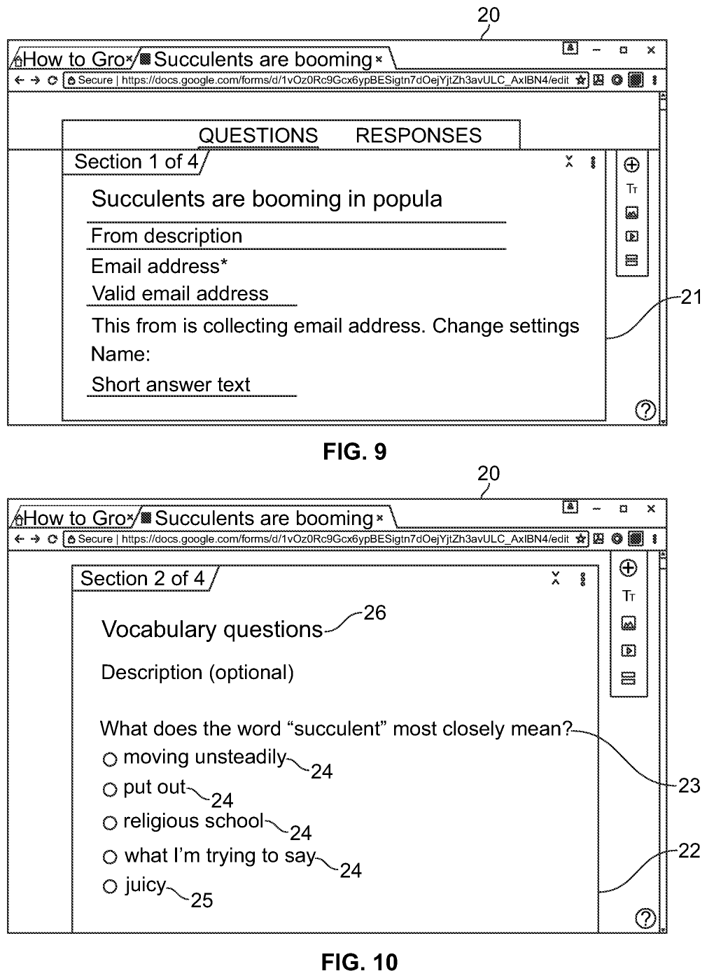

Turning to FIG. 9, upon the quiz and answer key being transmitted to the 3rd party quiz tool 1, the created quiz is displayed to the user within the 3rd party quiz tool (in this case, Google Forms) on the client computer 4, within the browser window 20. A box 21 is populated with the ability to name or rename the quiz and which displays to the quiz-creation user the information which will be asked of the quiz-taking users upon their beginning to take the quiz.

Turning to FIG. 10, which shows the same browser window 20 as in FIG. 9 with the screen scrolled down, shows the populated multiple choice question on the 3rd party quiz tool of vocabulary question section 22, which contains an informational header 26, and a plurality of quiz questions 23 each of which contains one or more correct answer choices 25 and a plurality of incorrect answer choices, or distractors, 24.

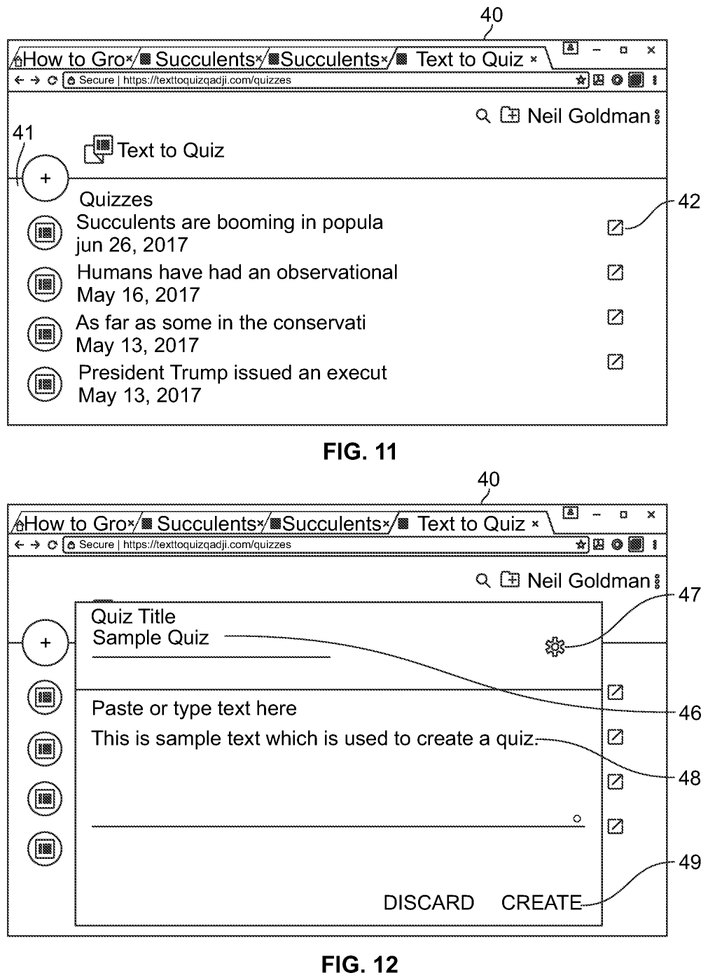

An alternative method of selecting arbitrary text (shown as step 60 in FIG. 2) is shown in FIG. 11. A browser window 40 contains a list of existing quizzes 42 along with an icon 41 which permits the entry of text which is not available within browser window 40. For example, the text which the user intends to be the basis of a quiz may be visible in a Word document or PDF file displayed elsewhere on the user's computer, and this method shown in FIG. 11 permits the user to use such text as the basis of a quiz.

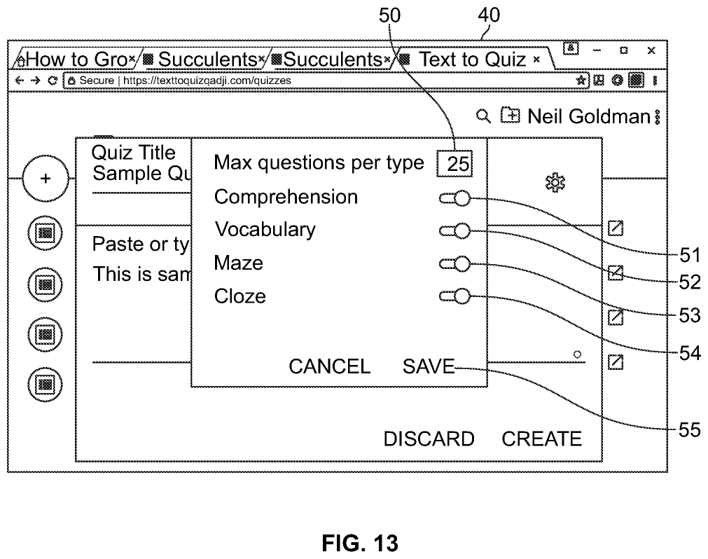

Upon clicking icon 41, the user is presented within browser window 40 a field 46 which permits the user to manually enter a new quiz name, a text-entry field 48 which permits the user to type or paste in a text passage, and a set of links which permits the user to cancel the operation or invoke the quiz creation function as shown as step 62 in FIG. 2. Also displayed in FIG. 12 is an option icon 47, which, if clicked, results in the display of a menu of quiz generation options, shown in FIG. 13. The user may select the maximum number of questions 50, whether or not comprehension questions are included 51, whether or not vocabulary questions are included 52, whether or not maze questions are included 53, and whether or not doze questions are included 54. Additional links are displayed 55 which permit the user to cancel the selection of options or save them.

Thus, there has been provided Applicant's method for multiple-choice quiz generation. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A method for creating a multiple-choice quiz, comprising the steps of:
receiving an arbitrary text passage from a user;
selecting from a set of menu choices using the following steps:
(a) providing a first menu choice for vocabulary questions;
(b) choosing from the first menu choice for vocabulary questions defining a vocabulary choice;
if the vocabulary choice is selected, performing the following steps:
(c) creating a plurality of words and a plurality of word definitions defining a word list, with at least one of the plurality of word definitions associated with each of the plurality of words;
(d) comparing the arbitrary text passage to one or more of the plurality of words in the word list;
(e) if a word from the arbitrary text passage matches one of the plurality of words in the word list defining a first matched word, performing the following step:
(i) creating a vocabulary question using the first matched word;
(ii) creating a first matched correct definition answer to the vocabulary question from the plurality of at least one word definitions associated with the first matched word;
(iii) randomly selecting a plurality of word definition distractors from the word list defining a plurality of incorrect word definition answers;
(iv) completing the vocabulary question using the plurality of incorrect word definition answers;
(f) if a word from the arbitrary text passage does not match one of the plurality of words in the word list, performing the following steps:
(i) creating a plurality of phrases and a plurality of phrase definitions defining a phrase list, with at least one of the plurality of phrase definitions associated with each of the plurality of list of phrases;
(ii) comparing the arbitrary text passage to one or more of the plurality of phrases in the phrase list;
(iii) if a phrase from the arbitrary text passage matches one of the plurality of phrases in the phrase list defining a first matched phrase, performing the following step:
(a) creating the vocabulary question using the first matched phrase;
(b) creating the first matched correct definition answer to the vocabulary question from the at least one of the plurality of phrase definitions associated with the first matched phrase;
(c) randomly selecting a plurality of phrase distractors from the phrase list defining a plurality of incorrect phrase definition answers;
(d) completing the vocabulary question using the plurality of incorrect phrase definition answers.

2. The method of claim 1 and further comprising the step of providing the arbitrary text passage from the group consisting of all of the text on a selected web page, all of the text on a selected article, and only certain selected text from the selected web page or selected article.

3. The method of claim 1 and further comprising the step of selecting a maximum number of questions per type from the set of menu choices.

4. The method of claim 1 and further comprising the step of selecting from the set of menu choices using the following steps:
(a) providing a second menu choice for comprehension questions;
(b) choosing from the second menu choice for comprehension questions defining a comprehension choice;
if the comprehension choice is selected, performing the following steps:
(c) creating a plurality of patterns and defining a pattern list;
(d) comparing the arbitrary text passage to one or more of the plurality of patterns in the pattern list;
(e) if a pattern from the arbitrary text passage matches one of the plurality of patterns in the pattern list defining a first matched pattern, performing the following steps:
(i) isolating a first information from the first matched pattern;
(ii) isolating a second information from the first matched pattern;
(iii) creating a comprehension question using the first information and the second information;
(iv) creating a first matched correct definition answer to the comprehension question from the first information or the second information;
(v) creating a plurality of types of information;
(vi) creating a plurality of entries for each of the plurality of types of information, with the plurality of types of information and the plurality of entries defining a comprehension distractor list;
(vii) assigning the first information or the second information into one of a plurality of types of information defining at least one information type;
(viii) randomly selecting a plurality of distractor entries from the plurality of entries in the comprehension distractor list for the at least one information type defining a plurality of incorrect information answers;
(ix) completing the comprehension question using the plurality of incorrect information answers.

5. The method of claim 4 and further comprising the step of creating the plurality of patterns from the group consisting of words, letters, text and numbers.

6. The method of claim 5 and further comprising the step of providing the plurality of patterns in the format of any combination of letters, spaces, capital letters, lowercase letters, commas, and words.

7. The method of claim 6 and further comprising the step of providing that the plurality of incorrect information answers does not match the first matched correct definition answer.

8. The method of claim 1 and further comprising the step of selecting from the set of menu choices using the following steps:
(a) providing a third menu choice for maze questions;
(b) choosing from the third menu choice for maze questions defining a maze choice;
if the maze choice is selected, performing the following steps:
(c) randomly selecting a number;
(d) counting each word in the arbitrary text passage from a starting point in the arbitrary text passage defining a counting number;
(e) matching the counting number to the number;
(f) determining a first word in the arbitrary text passage that corresponds to the counting number that matches the number;
(g) replacing the first word in the arbitrary text passage with the first word and a plurality of maze distractor replacements.

9. The method of claim 8 and further comprising the step of defining the starting point in the arbitrary text passage to be the second sentence from the beginning of the arbitrary text passage.

10. The method of claim 9 and further comprising the step of randomly selecting the plurality of maze distractor replacements defining a plurality of incorrect maze answers.

11. The method of claim 1 and further comprising the step of selecting from the set of menu choices using the following steps:
(a) providing a fourth menu choice for doze questions;
(b) choosing from the fourth menu choice for doze questions defining a doze choice;
if the doze choice is selected, performing the following steps:
(c) comparing the arbitrary text passage to one or more of the plurality of words in the word list;
(d) if a word from the arbitrary text passage matches one of the plurality of words in the word list defining a first doze word, performing the following step:
(e) replacing the first doze word in the arbitrary text passage with a marker.

12. The method of claim 11 and further comprising the step of defining the marker from the group consisting of an underline or blank.

13. The method of claim 12 and further comprising the step of creating a word bank.

14. The method of claim 13 and further comprising the step of providing the word bank having the first doze word and a plurality of doze distractor replacements.

15. The method of claim 14 and further comprising the step of randomly selecting the plurality of doze distractor replacements defining a plurality of incorrect doze answers.
